(19) United States
(12) Patent Application Publication
(10) Pub. No.: US 2005/0096021 A1
(43) Pub. Date: May 5, 2005

(54) Air time management

(75) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114, US

(73) Assignee: Lucent Technologies Inc.

(21) Appl. No.: 10/696,066

(22) Filed: Oct. 29, 2003

(51) Int. Cl. H04Q 7/00

(52) U.S. Cl. 455/415

(57) ABSTRACT

Calls are screened on the basis of a priority assigned to the calling party and a current cost (monetary or opportunity) to a communications service subscriber. For example, a calling line identification or a PIN is used to identify the calling party and to find a priority level assigned to the calling party by the subscriber. An applicable billing category is determined (e.g., a night or weekend, peak, or mobile to mobile billing category). An unused amount of air time or message units in a basic allotment of message units or air time is determined. If, given the amount of remaining message units or the cost of message units, the priority level assigned to the calling party justifies call completion; the user equipment of the calling party is connected to the user equipment of the subscriber. Otherwise, the user equipment of the calling party is connected to a message service or call completion is denied.

### BACKGROUND

The invention is related to the art of communications message unit management. The invention will be described in terms of mobile phone air time management. However, the invention may find application wherever message units are contracted for in pre-allocated blocks and additional charges apply whenever message units beyond the pre-allocated amount are consumed.

Mobile or cellular telephone service is sold or contracted for on the basis of time. For example, a subscriber may agree to pay a fee, monthly, over an extended period of time. For instance, a subscriber may agree to pay a fee every month or billing cycle, for a year, in exchange for mobile, cellular or wireless services. In return for paying the monthly fee, the subscriber may be allocated or budgeted a certain amount of pre-allocated air time. For example, the fee may cover 1,000 minutes of air time. Some subscription plans classify and allocate air time to subscribers in a number of ways. For example, some plans may allow subscribers an unlimited amount of air time during periods when bandwidth demands on the network are expected to be low. For instance, a subscriber's use of air time may be unlimited during evening hours and/or over the course of a weekend. Other plans might provide, for example, 5,000 minutes that can be used at night or on Saturday and Sunday and 500 additional minutes that can be used during peak demand hours (i.e., during normal business hours) or, if necessary, during evenings and weekends. If the subscriber uses more air time than is allocated or budgeted during a given allocation period (e.g., a month), the subscriber is charged additional fees (e.g., per-minute charges).

Therefore, there is a desire on the part of some subscribers to manage or budget their use of air time. In the United States, air time is paid for by the subscriber whether they are the calling party or the called party. While a subscriber may be able to keep track of their air time expenditures and limit there own mobile calling accordingly, it is more difficult to limit calls made by others to the subscriber. For example, telemarketers may call a subscriber's mobile equipment. If the subscriber answers the call, air time is consumed. The air time may be charged against the monthly allotment or may be billed to the subscriber on a per-minute basis.

Where a subscriber's user equipment and mobile subscription plan provide for the display of calling line identification information, the subscriber may manually manage air time by observing a calling line identification display indicating either a directory number, name or other identification of the calling party and deciding whether or not to take the call. Such a decision may be based on the time of day or day of the week and the subscriber's familiarity with provisions of the calling plan of the subscriber. For instance, the subscriber may be willing to take the call if air time is currently unlimited based on the time of day or the day of the week. However, some subscribers find this method of managing air time unsatisfactory because it requires that they interrupt other activity to access the calling line identification display and it requires them to remember the details of their calling plan in order to compare the present time with the air time allocation parameters of the plan.

Therefore, there is desire for an automated method for managing air time that reduces or eliminates interruptions to the subscriber's activities and relieves the subscriber from having to memorize the details of their air time allocations.

### SUMMARY

A method for managing message units includes receiving a list of potential calling parties associated with a subscriber, the list including identification information regarding the listed potential calling parties, associating a priority level to each of the listed potential calling parties and screening calls based on at least one of a calling line identification and a personal identification code associated with the calls and based on information included in the list of potential calling parties, on the associated priorities and on a current cost of message units.

Screening calls can include determining that the calling party is not a listed potential caller and assigning a low priority to the calling party. In some embodiments screening calls includes determining that the calling party is a listed potential caller and assigning the priority associated with the listed potential caller to the calling party. For example, screening calls can include determining a calling line identification associated with the calling party, comparing the calling line identification with the identification information of the listed potential calling parties, finding a calling line identification in the list of potential calling parties that matches the calling line identification associated with the calling party and assigning a priority level associated with the calling line identification found in the list of potential calling parties to the calling party. In other cases screening calls includes receiving a personal identification code from the calling party, comparing the personal identification code with the identification information of the listed potential calling parties, finding a personal identification code in the list of potential calling parties that matches the personal identification code received from the calling party and assigning a priority level associated with the personal identification code found in the list of potential calling parties to the calling party.

The screening process can include requesting billing information regarding the subscriber from a billing system. For instance, requesting billing information regarding the subscriber can include requesting information regarding unused allocated air time from an allotment of air time in an air time allocation period associated with the subscriber. Additionally, or alternatively requesting billing information regarding the subscriber from a billing system can include requesting information regarding a current cost to the subscriber of air time.

In one exemplary scenario screening calls can include completing the requested call to a mobile device of the subscriber if the current ration state is unrestricted and the priority level of the calling party is high.

Some embodiments include a method for managing air time. The method includes receiving a list of potential calling parties associated with a subscriber, the list including identification information regarding the listed potential calling parties, associating a priority level with each of the listed potential calling parties, receiving a call request from a calling party directed at user equipment of the subscriber, determining a priority level associated with the calling party, determining a current air time ration state associated with the subscriber and processing the call request according to the current ration state and the priority level of the calling party.

Determining the priority level associated with the calling party can be accomplished by determining that the calling party is not a listed potential caller and therefore, assigning a low priority to the calling party. Determining the priority level associated with the calling party can include determining that the calling party is a listed potential caller, and assigning the priority associated with the listed potential caller to the calling party. One way to determine the priority level associated with the calling party includes determining a calling line identification associated with the calling party, comparing the calling line identification with the identification information of the listed potential calling parties, finding a calling line identification in the list of potential calling parties that matches the calling line identification associated with the calling party and assigning a priority level associated with the calling line identification found in the list of potential calling parties to the calling party. Another way to determine the priority level associated with the calling party includes receiving a personal identification code from the calling party, comparing the personal identification code with the identification information of the listed potential calling parties, finding a personal identification code in the list of potential calling parties that matches the personal identification code received from the calling party and assigning a priority level associated with the personal identification code found in the list of potential calling parties to the calling party.

Determining the current air time ration state associated with the subscriber can include determining a remaining air time allocation period fraction associated with the subscriber, determining a remaining air time allocation fraction associated with the subscriber, determining a remaining air time allocation period to air time allocation fraction ratio associated with the subscriber and determining the current air time ration state based on the air time allocation period to air time allocation fraction ratio.

In some embodiments determining the current air time ration state associated with the subscriber includes calculating the current air time ration state based on a function of remaining allocated air time in an air time allocation period.

In some embodiments determining the current air time ration state associated with the subscriber includes calculating the current air time ration state based on a current subscriber cost of air time.

Determining the current air time ration state associated with the subscriber can include determining a current time associated with the subscriber, determining a remaining air time allocation associated with the current time and determining the current air time ration state as a function of the remaining air time allocation. Determining a current time can include determining a current day of a week. Additionally or alternatively determining a current time can include determining a current time of day.

Processing the call according to the current ration state and the priority level can include, for example, completing the requested call to a mobile device of the subscriber if the current ration state is unrestricted and the priority level of the calling party is high, or connecting the calling party to a message service if the current ration state is at a maximum restriction and the priority level of the calling party is low.

Determining the current air time ration state associated with the subscriber can also include requesting billing information regarding the subscriber from a billing system. For example requesting billing information regarding the subscriber from a billing system can include requesting information regarding unused allocated air time from an allotment of air time in an air time allocation period associated with the subscriber and/or requesting information regarding a current cost to the subscriber of air time.

For example, a system for managing message units can include means for receiving a list of potential calling parties associated with a subscriber, the list including identification information regarding the listed potential calling parties, means for associating a priority level with each of the listed potential calling parties, means for receiving a call request from a calling party directed at user equipment of the subscriber, means for determining a priority level associated with the calling party, means for determining a current message unit ration state associated with the subscriber, and means for processing the call request according to the current ration state and the priority level of the calling party.

One embodiment includes a system operative to conserve message units for a subscriber. The system includes a potential caller list manager, a message unit conserver and a call processor. The potential caller list manager can be operative to receive and maintain a list of potential callers in association with priority levels of the callers. The list is associated with the subscriber. The message unit conserver can be operative to determine a priority of a calling party based on the list of potential callers and to determine a current message unit ration state based on a current cost of message units to the subscriber. The call processor can be operative to process a call request of the calling party based on the determined priority of the calling party and the determined current message unit ration state.

For example, the message unit conserver can be operative to determine the current message unit ration state based on a current opportunity cost measured in terms of remaining message units from a basic allotment of message units in a message unit allocation period.

In some embodiments the message unit conserver is operative to determine a priority of a calling party based on the list of potential callers and to determine a current message unit ration state based on a current cost of message units to the subscriber.

In some embodiments the message unit conserver is operative to request a current message unit billing category associated with the subscriber from a billing system, to receive the current message unit billing category and use the current billing category to determine the current message unit ration state based on a current cost of message units to the subscriber.

In some embodiments the message unit conserver is operative to request information from a billing system regarding used message unit in a current message unit billing category from an allotment of message units in the current message unit billing category associated with the subscriber, to receive the information regarding the used message units and use the information regarding the used message unit to determine the current message unit ration state.

### BRIEF DESCRIPTION OF THE DRAWINGS

The invention may take form in various components and arrangements of components, and in various procedures and arrangements of procedures. The drawings are only for purposes of illustrating preferred embodiments, they are not to scale, and are not to be construed as limiting the invention.

FIG. 1 is a flow chart outlining a method for managing message units or air time.

FIG. 2 is a block diagram of a system operative to manage message units or air time.

FIG. 3 is a call flow diagram outlining exemplary call processing scenarios associated with embodiments of the method of FIG. 1 and the system of FIG. 2.

### DETAILED DESCRIPTION

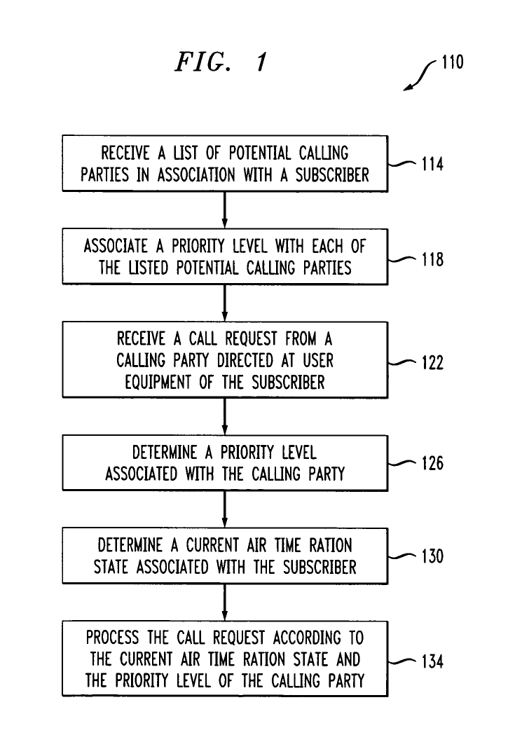

Referring to FIG. 1, a method 110 for managing message units or air time includes receiving 114 a list of potential calling parties and associating 118 a priority level with each of the listed potential calling parties. The list of potential calling parties and associated priority levels are used to screen calls. For example, once the list and associated priority levels are established, when a call request directed at user equipment of the subscriber is received 122 from a calling party, the list and associated priorities are used to make a determination 126 as to a priority level of the calling party. Additionally, a determination 130 is made as to a current message unit or air time ration state associated with the subscriber. The call request is then processed 134 according to the current ration state and the priority level of the calling party.

For example, receiving 114 a list of potential calling parties can include receiving a conservation feature configuration call from the subscriber. Through keypad entry, short message service (SMS) communications, voice recognition or other means the subscriber provides identification information related to people or entities the subscriber expects calls from. For instance, the list includes directory numbers associated with the expected or potential calling parties. The list may include names of the calling parties. Additionally, or as an alternative to the directory number information, the list may include identification codes associated with the potential calling parties. For instance, the subscriber may agree on or assign personal identification numbers (PIN) with or to the listed potential calling parties. Additionally, through additional keyboard entry, SMS messages, voice recognition or other means, the subscriber associates 126 a priority level with each of the listed potential calling parties. For example, the subscriber assigns a high, medium or low priority to each of the listed potential calling parties. A call from a calling party associated with a high priority may be completed through to user equipment of the subscriber independent of the determined 130 current air time ration state. Calls from calling parties associated with a low priority may only be completed when the current air time ration state is relatively unrestricted. Calls from calling parties associated with a mid-range priority level may be completed when the air time ration state is at a somewhat restricted level but not when air time rationing is at its most restricted.

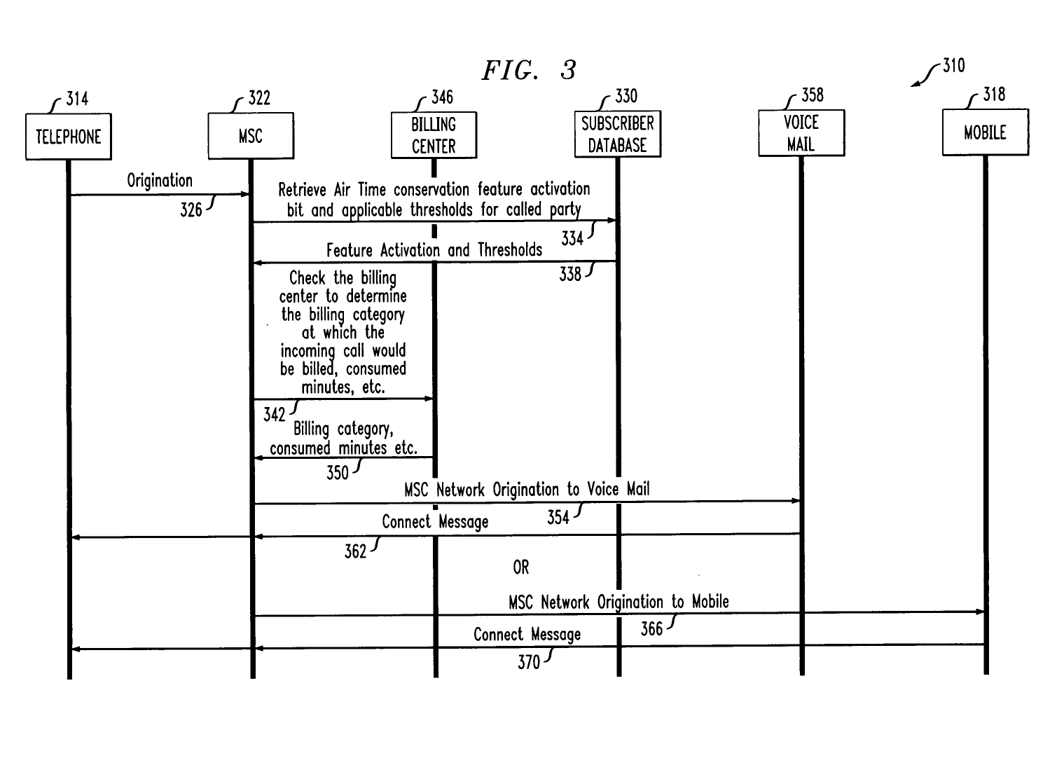

Determining 126 the priority level associated with a calling party can include determining a calling line identification associated with the calling party. For example, the directory number of the user equipment being used by the calling party may be supplied in a caller ID field of a message (see FIG. 3) associated with the received 122 call request. The calling line identification information is compared with the potential calling party identification information included in the received 114 list of potential calling parties. If a directory number matching the calling line identification is included in the list of potential calling parties, then the priority level associated 118 with the directory number in the list is assigned to the calling party. If no directory number matching the calling line identification information is found in the list of potential calling parties, the calling party may be assigned the default priority level. For instance, the calling party may be assigned a low priority.

Alternatively, the calling party may be sent a message (e.g., recorded voice message, synthesized voice message or SMS message) requesting the entry of an identification code such as, for example, a personal identification number (PIN). The identification code may be entered through any known technique such as, for example, voice recognition, keypad entry or SMS message. If an identification code is received, it is compared with identification information included in the received 114 list of potential calling parties. If an identification code matching the identification code entered by the calling party is found in the received 114 list of potential calling parties, the calling party is assigned the priority level associated with the identification code found in the list of potential calling parties.

The current message unit or air time ration state can be determined by a wide variety of methods based on a wide array of algorithms. For example, if the requested call would be associated with unlimited air time minutes in the subscriber's calling plan, because, for example, the current time of day or the current day of the week is associated with unlimited air time or because the user equipment of the calling party is a mobile device and the subscriber has unlimited access to mobile-to-mobile air time, the current air time ration state is readily determined to be --UNRESTRICTED--. If, on the other hand, the requested call would be associated with more expensive or more limited so-called “anytime” minutes, a more complicated algorithm may be used to determine 130 the current air time ration state. For instance, if the subscriber has already used a number of “anytime” minutes above a first threshold in a current air time allocation period, the current air time ration state may be --MODERATELY RESTRICTED--. If the number of anytime minutes used by the subscriber exceeds a second threshold, the current air time ration state may be determined to be --MAXIMALLY RESTRICTED--. In such a scenario, the message unit or air time allocation period may be, for example, a current calendar month or other 30-day period. Alternatively, the allocation period may be a single day or a single week with the thresholds being adjusted to reflect the daily or weekly allocation of a prorated portion of the monthly or billing cycle air time or message unit allotment. Unused minutes or message units from the allotment of a preceding day, week, or billing cycle period may be carried over the current day, week or billing cycle with thresholds being automatically adjusted to account for the increase in available message units or air time.

A subscriber may decide to manually adjust thresholds to provide for looser air time rationing during periods when the subscriber expects an increase in important or desired calls.

Another method for determining 130 the current air time ration state is based on determining a remaining air time allocation period to remaining air time allocation fraction ratio associated with the subscriber. For instance, the fraction of an air time allocation period remaining is determined (e.g., 0.34 of the month is remaining) as is a remaining air time allocation fraction (e.g., 0.52 of the billing cycle's allocation of “anytime” minutes are unused). The current air time ration state is determined based on a ratio of the air time allocation period and remaining air time allocation fractions or percentage (e.g., 0.34/0.52). For instance, when the air time allocation period to air time allocation fraction ratio is less than 1, the current air time ration state maybe unrestricted. When the fraction ratio is greater than 1, the air time ration state is increasingly more restricted.

Another method for determining the current air time ration state is based on a mathematical function of remaining prepaid air time in an air time allocation period. For example, as long as there is at least 100 minutes remaining in the current month, the current air time ration state is unrestricted. As the available minutes drop below 100, the ration state becomes more and more restrictive. Under this scenario, the priority levels associated 118 with the listed potential caller's may be numerical values which are compared to a numerical value of the mathematical function.

Other methods for determining 130 the current air time ration state may be based on the current cost to the subscriber of air time. For instance, where a subscriber's service plan does not include any basic allotment of air time or where the subscriber's basic allotment of air time has been consumed for the current allocation period, the current ration state is determined based on the current cost of air time. For example, if the call request is received 122 during a high network demand time (e.g., during a work day) when rates are high, the current air time ration state may be relatively restricted. During nights and weekends when the cost of minutes is low or when minutes are free, the current air time ration state may be determined 130 to be relatively unrestricted.

Processing 134 the call request according to the current air time ration state and the priority level associated with the calling party can include granting the received 122 call request (i.e., connecting the calling party to the user equipment of the subscriber), connecting the user equipment of the calling party to a message or voice mail service of the subscriber, or denying the received 114 call request. The priority level determined 126 to be associated with the calling party and the current air time ration state determined 130 to be associated with the subscriber are factors used to determine the appropriate processing. For example, calls from calling parties associated with high priority may be completed independent of the current air time ration state or may be connected when the ration state is at all but the most restrictive state. Calls from calling parties associated with mid-level priorities may be connected to the user equipment of the subscriber when the ration state is at an intermediate level of restriction or when air time is not being rationed. In most cases, calls that are not connected to the user equipment of the subscriber are directed to a message or voice mail service of the subscriber. However, calls associated with the lowest priority may be denied. For instance, calls that are not associated with calling line identifications or identification codes (e.g., PINs) that are included in the received 114 list of potential calling parties may be sent a message indicating that the subscriber is restricting access and that the call cannot be completed. Of course, the subscriber may elect to receive calls from callers not associated with the list of potential calling parties when the call rationing state is unrestricted or at any level of restriction desired by the subscriber.

Whenever call completion is denied or when a call is directed to a messaging service, the calling party may be sent a message indicating a time of day or day of the week when, based on their priority level, their call is more likely to be completed.

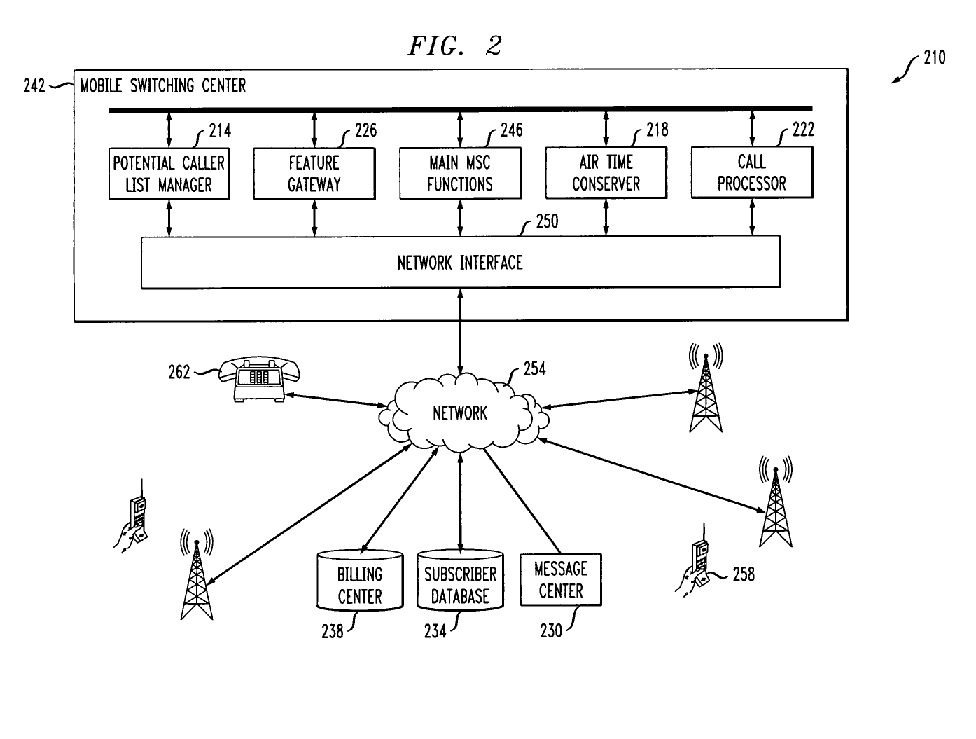

Referring to FIG. 2, a system 210 operative to manage message units or air time includes a potential caller list manager 214, an air time conserver 218 and a call processor 222. Additionally, the system 210 may include a feature gateway 226 and/or a message center 230. The system 210 may include or communicate with a subscriber database 234 and a billing center 238. For instance, portions (e.g., 214, 218, 222, 226) of the system 210 may be implemented within a mobile switching center 242 as secondary or optional functions thereof. Main mobile switching center functions 246 include the routing and termination of calls. A network interface 250 of the mobile switching center 242 provides connectivity between the mobile switching center 242 and a communications network 254. The network 254 may provide access to and for wireless 258 and wired 262 user equipment as well as access to the billing center 238, subscriber database 234 and message center 230.

The potential caller list manager 214 receives 114 the list of potential calling parties and facilitates the association 118 of a priority level with each of the listed potential calling parties. For instance, a subscriber uses a wired 262 or wireless 258 device to contact the list manager 214 and upload or enter the list of potential calling parties. The list manager 214 provides the subscriber with menu options. For instance, the list manager provides the subscriber with a recorded or synthesized voice menu for selecting various list entering and editing functions. Alternatively, the menu is provided in the form of a web page or other written and/or hyperlink format. The subscriber navigates the menu and enters or edits the list of potential calling parties providing, for example, directory numbers, identification codes (e.g., PINs), and/or names in association with each potential calling party. Additionally, the subscriber navigates the menu to associate 118 a priority level with each of the listed potential calling parties. For instance, a default priority (e.g., low) may be initially assigned to each of the listed potential calling parties. The subscriber may select some or all of the listed potential calling parties and change their priority level (e.g., to a mid-level or high priority). When the subscriber is finished providing this configuration information, the connection between the subscriber and the potential caller list manager 214 may be torn down. In some embodiments, the potential caller list manager 214 stores the received 114 list and associated 118 priority levels in the subscriber database 234. Alternatively, the list and priority levels may be stored locally to the list manager 214. For example, the list and priority levels may be stored in a database (not shown) of the mobile switching center 242.

When a call request is received 122, the air time conserver 218 determines 126 a priority level associated with the calling party and determines 130 the current air time ration state associated with the subscriber. For example, the air time conserver 218 accesses the subscriber database 234 using information from the received 122 call request. For instance, the air time conserver 218 uses a directory number of the subscriber to access the received 114 list of potential calling parties associated with the subscriber. The air time conserver 218 compares the received information with information about the calling party. For example, the air time conserver compares an identification code (e.g., PIN) or a calling line identification (e.g., the directory number of the calling party) to the identification information stored in the list. If a matching code or calling line identification is found in the list, the air time conserver 218 assigns the priority level associated with the matching information in the list to the calling party. Alternatively, if identification information from the calling party does not match identification information associated with the list of potential calling parties, the air time conserver associates a default priority (e.g., low) to the calling party.

The message unit or air time conserver 218 determines 130 the current air time ration state by determining a monetary cost or opportunity cost currently associated with a service plan of the subscriber. For instance, the message unit or air time conserver 218 accesses the billing center 238 (through the services of the network interface 250 and the network 254) and collects information regarding monetary cost or opportunity cost of message units or air time to the subscriber. For example, the conserver 218 may determine that the subscriber would be charged for message units at a peak demand rate, a night or weekend rate, a mobile-to-mobile rate or some other rate. Additionally, the conserver 218 determines whether the message units would be deducted from a standard message unit or air time allocation (opportunity cost) associated with the service plan of the subscriber or if the subscriber would be charged additional fees (monetary cost) if the requested 122 call were to be completed.

The air time conserver 218 then determines or calculates a current air time or message unit ration state based on any of a wide variety of algorithms. For example, as explained above, the ration state may simply be based on whether or not a threshold level of message units or air time has already been consumed for the current allocation period (e.g., the current day, week or month). Alternatively, if the subscriber's service plan does not include a base or prepaid allocation of message units or air time, or if the subscriber has used the entire basic allocation or prepaid message units or air time, the calculation of the current air time ration state might be based on a current subscriber monetary cost of air time or message units.

Where the subscriber's service plan does include a basic allocation of one or more categories of bandwidth or air time, the bandwidth or air time conserver 218 may determine a remaining air time allocation period fraction (e.g., what fraction of days of the month remain in the current month), determining a remaining air time allocation fraction associated with the subscriber. For example, the conserver 218 determines that a night and weekend billing rate currently applies. The conserver 218 then determines what fraction of the subscriber's basic allocation period night or weekend minutes remain to be used. The message unit or air time conserver 218 then compares the remaining air time allocation period fraction and the remaining air time allocation fraction to determine a remaining air time allocation period to remaining air time allocation fraction ratio associated with the subscriber. For instance, if ten days remain in the air time allocation period or billing cycle, then the remaining air time allocation period fraction is one-third (based on a 30-day month). If the current time is associated with high network demand and, therefore, with an --anytime minute-- billing rate, the conserver 218 determines how many minutes are in the subscribers basic monthly allocation or prepaid --anytime minutes-- and determines how many of those anytime minutes remain to be consumed. For example, if the subscriber receives 500 anytime minutes in the basic monthly allocation and 250 minutes remain to be used, then the remaining air time allocation period fraction to air time allocation fraction ratio is one-third divided by one-half or 0.66. Since this ratio is less than one, there may be message units or air time to spare, and the current air time or message units ration state may be determined to be relatively unrestricted.

When the message unit or air time conserver 218 determines the current air time ration state, the conserver 218 passes the current air time ration state to the call processor 222.

The call processor 222 processes 134 the call request according to the current air time or message unit ration state and the priority level of the calling party. If the priority of the calling party is low and the current ration state is relatively restricted, the call processor 222 might direct the call to the message center 230. For example, the call processor 222 accesses main mobile switching center functions 246 to route the call to the message center 230. The message center may send a message to the calling party indicating that the call is being rejected. Alternatively, the caller is sent a message explaining that the subscriber is currently unavailable and offering the caller an opportunity to record a message. If the caller records a message, the message center 230 may notify the subscriber that a message is waiting. For example, the message center may send a SMS message to user equipment of the subscriber. Alternatively, the subscriber may simply check for messages at convenient intervals.

If the priority assigned to the calling party is relatively high and the current message unit or air time ration state is relatively low, then the received 122 call request is honored, the user equipment of the subscriber is alerted and the user equipment of the calling party is connected to the user equipment of the subscriber through the services of the network 254.

If only some subscribers subscribe to or receive message unit or air time conservation services, then the system 210 may include the feature gateway 226. When a call request is received 122, the feature gateway 226 determines if the called party subscribes to or receives message unit or air time conservation services. For instance, the feature gateway 226 accesses the subscriber database 234 (through the services of the network interface 250 and network 254) using information in the call request. For example, the feature gateway 226 accesses the subscriber database 234 with the directory number of the called party. The feature gateway 226 requests subscriber subscription information from the subscriber database 234. If the subscription information indicates that the subscriber uses message unit or air time conservation services, the feature gateway 226 turns control over to the air time conserver 218. If the subscriber does not use message unit or air time conservation services, the feature gateway 226 returns call processing to the main MSC functions 246.

Referring to FIG. 3, in an exemplary scenario 310, a calling party uses calling party user equipment 314 in an attempt to place a call to user equipment 318 of a mobile communications subscriber. The calling plan of the subscriber includes air time conservation services. The user equipment 314 of the calling party is connected through one or more networks (not shown) to a serving mobile switching center (MSC) 322 associated with the user equipment 318 of the subscriber. The user equipment 314 of the calling party transmits or instigates the transmission of an origination message 326 to the MSC 322. The MSC 322 includes or is in communication with an embodiment of the system 210 for managing air time or message units which has previously received 114 a list of potential calling parties and associated 118 each listed potential calling party with a priority level as described above.

The MSC 322 receives 122 the origination message 326 as a call request from the calling party directed at the user equipment 318 of the subscriber. The main MSC functions 246 of the MSC 322 notify the feature gateway 226 of the call request. The feature gateway 226 locates a subscriber database 330 associated with the subscriber. For example, the subscriber database 330 is associated with a home location register (not shown) of the subscriber. The feature gateway 226 sends one or more messages to the subscriber database 330 requesting information about the subscriber's service subscriptions and service configuration information. For example, the feature gateway 226 requests 334 a state of an air time conservation feature activation bit and, if the state of the bit indicates that the subscriber uses an air time conservation service, applicable conservation service configuration information. For instance, feature gateway 226 requests thresholds for use in determining a current air time ration state and requests a list of potential calling parties and associated priority levels.

The subscriber database 330 responds by transmitting one or more messages 338 providing the state of the air time conservation feature activation bit and configuration information to the MSC. Since the air time conservation feature activation bit indicates that the subscriber uses the air time conservation service, the feature gateway 226 passes control and the received information to the message unit or air time conserver 218.

The conserver 218 uses the information it receives from the feature gateway 226 to determine 126 a priority level associated with the calling party. Additionally, the conserver 218 collects information in order to determine 130 the current air time ration state to be associated with the subscriber. For example, the bandwidth or air time conserver 218 transmits 342 one or more information requests to a billing center 346 associated with the subscriber. For example, the transmitted 342 messages request a billing category (e.g., nights and weekends, mobile-to-mobile, anytime) at which the requested call would be billed or charged to the subscriber if it were completed. Additionally, the transmitted 342 messages may request information about the subscriber's calling plan including, for example, the number of available minutes in a basic allotment for the current allocation period in the current billing category and/or the number of minutes in that category that have already been consumed. In response, the billing center 346 transmits 350 the requested information to the message unit or air time conserver 218. The conserver 218 uses the information to determine 130 the current air time ration state. For example, the conserver 218 compares a configured threshold received from the subscriber database 330 through the feature gateway 226 with the consumed minutes information received from the billing center 346. If the consumed minutes are at or above the threshold, the current air time ration state is determined to be --RESTRICTED--. If the number of consumed minutes is below the threshold, the current air time ration state is determined 130 to be UNRESTRICTED. The current air time ration state and the priority level determined 126 to be associated with the calling party are passed to the call processor 222.

The call processor 222 processes 134 the call request according to the air time ration state and priority level received from the air time bandwidth conserver 218. For instance, If the current air time ration state is --RESTRICTED-- and the priority level associated with the calling party is relatively low, the call processor 222 may send an MSC_Network origination message 354 to a voice mail adjunct 358 requesting a connection be made to the user equipment 314 of the calling party. The voice mail adjunct 358 responds by transmitting a connect message 362 to the user equipment 314 of the calling party through the services of the MSC 322 thereby establishing a connection between the user equipment 314 of the calling party and the voice mail system 358. The voice mail system 358 may send one or more messages to the user equipment 314 of the calling party explaining that the call has been redirected to the voice mail system 358 and offering the calling party the option of leaving a message.

If the current air time or bandwidth ration state is --UNRESTRICTED--, the call processor 222 transmits an MSC_Network origination message 366 to the user equipment 318 of the subscriber. In response, the user equipment 318 of the subscriber alerts (assuming the user equipment 318 is operating and within range of a serving cell site (not shown)). If the subscriber responds to the alert by answering, a connect message 370 is transmitted to the user equipment 314 of the calling party through the services of the network (e.g., 254) including the MSC 322, thereby terminating the call and allowing the calling party to communicate with the subscriber.

The invention has been described with reference to preferred embodiments. Obviously, modifications and alterations will occur to others upon reading and understanding the present specification. For instance, embodiments of the invention have been described as being associated with a mobile switching center. However, the systems and methods described can be implemented in other devices in various combinations of software and hardware. Embodiments of the invention can be applied in wired networks in, for example, conjunction with long distance services and toll charges. The procedures of the invention can be performed by other combinations of functional blocks and in association with other network components. It is intended that the invention be construed as including all such modifications and alterations insofar as they come within the scope of the appendent claims or equivalents thereof.

1. A method for managing message units, the method comprising:
receiving a list of potential calling parties associated with a subscriber, the list including identification information regarding the listed potential calling parties;
associating a priority level to each of the listed potential calling parties; and,
screening calls based on at least one of a calling line identification and a personal identification code associated with the calls and based on information included in the list of potential calling parties, on the associated priorities and on a current cost of message units.

2. The method of claim 1 wherein screening calls comprises:
determining that the calling party is not a listed potential caller; and
assigning a low priority to the calling party.

3. The method of claim 1 wherein screening calls comprises:
determining that the calling party is a listed potential caller; and
assigning the priority associated with the listed potential caller to the calling party.

4. The method of claim 1 wherein screening calls comprises:
determining a calling line identification associated with the calling party;
comparing the calling line identification with the dentification information of the listed potential calling parties;
finding a calling line identification in the list of potential calling parties that matches the calling line identification associated with the calling party; and
assigning a priority level associated with the calling line identification found in the list of potential calling parties to the calling party.

5. The method of claim 1 wherein screening calls comprises:
receiving a personal identification code from the calling party;
comparing the personal identification code with the identification information of the listed potential calling parties;
finding a personal identification code in the list of potential calling parties that matches the personal identification code received from the calling party; and
assigning a priority level associated with the personal identification code found in the list of potential calling parties to the calling party.

6. The method of claim 1 wherein screening calls comprises:
completing the requested call to a mobile device of the subscriber if the current ration state is unrestricted and the priority level of the calling party is high.

7. The method of claim 1 wherein screening calls comprises:
requesting billing information regarding the subscriber from a billing system.

8. The method of claim 7 wherein requesting billing information regarding the subscriber from a billing system comprises:
requesting information regarding unused allocated air time from an allotment of air time in an air time allocation period associated with the subscriber.

9. The method of claim 7 wherein requesting billing information regarding the subscriber from a billing system comprises:
requesting information regarding a current cost to the subscriber of air time.

10. A method for managing air time, the method comprising:
receiving a list of potential calling parties associated with a subscriber, the list including identification information regarding the listed potential calling parties;
associating a priority level with each of the listed potential calling parties;
receiving a call request from a calling party directed at user equipment of the subscriber;
determining a priority level associated with the calling party;
determining a current air time ration state associated with the subscriber; and
processing the call request according to the current ration state and the priority level of the calling party.

11. The method of claim 10 wherein determining the priority level associated with the calling party comprises:
determining that the calling party is not a listed potential caller; and
assigning a low priority to the calling party.

12. The method of claim 10 wherein determining the priority level associated with the calling party comprises:
determining that the calling party is a listed potential caller; and
assigning the priority associated with the listed potential caller to the calling party.

13. The method of claim 10 wherein determining the priority level associated with the calling party comprises:
determining a calling line identification associated with the calling party;
comparing the calling line identification with the identification information of the listed potential calling parties;
finding a calling line identification in the list of potential calling parties that matches the calling line identification associated with the calling party; and
assigning a priority level associated with the calling line identification found in the list of potential calling parties to the calling party.

14. The method of claim 10 wherein determining the priority level associated with the calling party comprises:
receiving a personal identification code from the calling party;
comparing the personal identification code with the identification information of the listed potential calling parties;
finding a personal identification code in the list of potential calling parties that matches the personal identification code received from the calling party; and
assigning a priority level associated with the personal identification code found in the list of potential calling parties to the calling party.

15. The method of claim 10 wherein determining the current air time ration state associated with the subscriber comprises:
determining a remaining air time allocation period fraction associated with the subscriber;
determining a remaining air time allocation fraction associated with the subscriber;
determining a remaining air time allocation period to air time allocation fraction ratio associated with the subscriber; and,
determining the current air time ration state based on the air time allocation period to air time allocation fraction ratio.

16. The method of claim 10 wherein determining the current air time ration state associated with the subscriber comprises:
calculating the current air time ration state based on a function of remaining allocated air time in an air time allocation period.

17. The method of claim 10 wherein determining the current air time ration state associated with the subscriber comprises:
calculating the current air time ration state based on a current subscriber cost of air time.

18. The method of claim 10 wherein determining the current air time ration state associated with the subscriber comprises:
determining a current time associated with the subscriber;
determining a remaining air time allocation associated with the current time; and,
determining the current air time ration state as a function of the remaining air time allocation.

19. The method of claim 18 wherein determining a current time comprises:
determining a current day of a week.

20. The method of claim 18 wherein determining a current time comprises:
determining a current time of day.

21. The method of claim 10 wherein processing the call according to the current ration state and the priority level comprises:
completing the requested call to a mobile device of the subscriber if the current ration state is unrestricted and the priority level of the calling party is high; and
connecting the calling party to a message service if the current ration state is at a maximum restriction and the priority level of the calling party is low.

22. The method of claim 10 wherein determining the current air time ration state associated with the subscriber comprises:
requesting billing information regarding the subscriber from a billing system.

23. The method of claim 22 wherein requesting billing information regarding the subscriber from a billing system comprises:
requesting information regarding unused allocated air time from an allotment of air time in an air time allocation period associated with the subscriber.

24. The method of claim 22 wherein requesting billing information regarding the subscriber from a billing system comprises:
requesting information regarding a current cost to the subscriber of air time.

25. A system operative to conserve message units for a subscriber, the system comprising:
a potential caller list manager operative to receive and maintain a list of potential callers in association with priority levels of the callers, the list being associated with the subscriber;
a message unit conserver operative to determine a priority of a calling party based on the list of potential callers and to determine a current message unit ration state based on a current cost of message units to the subscriber; and
a call processor operative to process a call request of the calling party based on the determined priority of the calling party and the determined current message unit ration state.

26. The system of claim 25 wherein the message unit conserver is operative to determine the current message unit ration state based on a current opportunity cost measured in terms of remaining message units from a basic allotment of message units in a message unit allocation period.

27. The system of claim 25 wherein the message unit conserver is operative to determine a priority of a calling party based on the list of potential callers and to determine a current message unit ration state based on a current cost of message units to the subscriber.

28. The system of claim 25 wherein the message unit conserver is operative to request a current message unit billing category associated with the subscriber from a billing system, to receive the current message unit billing category and use the current billing category to determine the current message unit ration state based on a current cost of message units to the subscriber.

29. The system of claim 25 wherein the message unit conserver is operative to request information from a billing system regarding used message unit in a current message unit billing category from an allotment of message units in the current message unit billing category associated with the subscriber, to receive the information regarding the used message units and use the information regarding the used message unit to determine the current message unit ration state.

30. A system for managing message units, the method comprising:
means for receiving a list of potential calling parties associated with a subscriber, the list including identification information regarding the listed potential calling parties;
means for associating a priority level with each of the listed potential calling parties;
means for receiving a call request from a calling party directed at user equipment of the subscriber;
means for determining a priority level associated with the calling party;
means for determining a current message unit ration state associated with the subscriber; and
means for processing the call request according to the current ration state and the priority level of the calling party.
